(19) United States
(12) Patent Application Publication
(10) Pub. No.: US 2018/0114078 A1
(43) Pub. Date: Apr. 26, 2018

(54) VEHICLE DETECTION DEVICE, VEHICLE DETECTION SYSTEM, AND VEHICLE DETECTION METHOD

(71) Applicant: JVC KENWOOD Corporation, Yokohama-shi (JP)

(72) Inventor: Shigetoshi TOKITA, Yokohama-shi (JP)

(21) Appl. No.: 15/848,191

(22) Filed: Dec. 20, 2017

Related U.S. Application Data
(63) Continuation of application No. PCT/JP2016/066457, filed on Jun. 2, 2016.

(30) Foreign Application Priority Data
Aug. 20, 2015 (JP) 2015-162892

(51) Int. Cl. G06K 9/00; B60R 1/00; B60R 11/04; G06T 7/20

(52) U.S. Cl. CPC G06K 9/00825; B60R 1/00; B60R 11/04; G06T 2207/30252; B60R 2300/8066; B60R 2300/105; B60R 2300/804; G06T 7/20

(57) ABSTRACT

An image acquisition unit in a vehicle detection device acquires an image input from an imaging device capable of imaging a scene diagonally behind a vehicle. A first image recognition unit searches an area, in the image acquired, in which to detect a vehicle located diagonally behind by using a discriminator for detecting a front of a vehicle, and detects a vehicle from within the area. A second image recognition unit extracts, in the image acquired, a plurality of feature points from within an area in which the vehicle detected by the first image recognition unit is present or estimated to be present, detects an optical flow of the feature points, and tracks the vehicle in the image. A detection signal output unit outputs a detection signal indicating that the vehicle is detected diagonally behind to a user interface.

### CROSS-REFERENCE TO RELATED APPLICATION

This application is a Continuation of International Application No. PCT/JP2016/066457, filed on Jun. 2, 2016, which in turn claims the benefit of Japanese Application No. 2015-162892, filed on Aug. 20, 2015, the disclosures of which Application is incorporated by reference herein.

### BACKGROUND OF THE INVENTION

### 1. Field of the Invention

The present invention relates to a vehicle detection device, vehicle detection system, and vehicle detection method for detecting another vehicle located diagonally behind a vehicle.

### 2. Description of the Related Art

In the presence of a plurality of driving lanes in the same direction, a vehicle in the adjacent lane and located diagonally behind (hereinafter, referred to as a vehicle diagonally behind) may enter a dead zone and go unnoticed by the driver. This may be addressed by installing a back camera in the rear part of the vehicle and detecting a vehicle in a captured image using image recognition (see, for example, patent document 1). The way that a vehicle diagonally behind appears in the image captured by the back camera varies depending on the distance between the vehicle provided with the back camera and the vehicle diagonally behind. When the vehicle diagonally behind is located at a long distance, virtually the front of the vehicle diagonally behind is seen. When the vehicle diagonally behind is located at a middle distance, the vehicle appears diagonally facing the driver's vehicle. When the vehicle diagonally behind is located at a short distance, the vehicle appears facing sideways. Thus, in scenes where the vehicle diagonally behind approaches the driver's vehicle to overtake the driver's vehicle, the way that the vehicle diagonally behind appears in the image captured by the back camera varies significantly.

It is generally difficult to precisely recognize an object with a significant change in the appearance in an image. For example, it is possible for a discriminator that has learned a large number of images of the front of vehicles to recognize a vehicle diagonally behind at a long distance. In the short to middle distances, however, the appearance varies significantly so that recognition becomes difficult. One possible approach is to use a combination of a plurality of discriminators that have learned images showing vehicles facing diagonally and vehicles facing sideways, in addition to the discriminator for vehicle front.

[patent document 1] JP2008-262401

When the vehicle diagonally behind at a short distance approaches nearer, the vehicle diagonally behind leaves the screen and will no longer be shown. It is therefore difficult to detect the vehicle using the learning-based discriminator mentioned above. The user of a plurality of discriminators increases the computational volume and requires high-specification hardware resources, resulting in an increase in the cost. Installation of two cameras or radars on either side of the vehicle makes it unnecessary to consider the impact from the change in the appearance but increases the cost.

### SUMMARY OF THE INVENTION

To address the aforementioned issue, a vehicle detection device according to an embodiment comprises: an image acquisition unit that is mounted to a vehicle and acquires an image input from an imaging device capable of imaging a scene diagonally behind the vehicle; a first image recognition unit that searches an area, in the image acquired, in which to detect a vehicle located diagonally behind by using a discriminator for detecting a front of a vehicle, and detects a vehicle from within the area; a second image recognition unit that extracts, in the image acquired by the image acquisition unit, a plurality of feature points from within an area in which the vehicle detected by the first image recognition unit is present or estimated to be present, detects an optical flow of the feature points, and tracks the vehicle in the image; and a detection signal output unit that, when a vehicle located diagonally behind is detected in the image by the first image recognition unit or the second image recognition unit, outputs a detection signal indicating that the vehicle is detected diagonally behind to a user interface for notifying a driver that the vehicle is present diagonally behind.

Another embodiment relates to a vehicle detection system. The vehicle detection system comprises: an imaging device mounted to a vehicle and capable of imaging a scene diagonally behind the vehicle; and a vehicle detection device connected to the imaging device. The vehicle detection device includes: an image acquisition unit that acquires an image input from the imaging device; a first image recognition unit that searches an area, in the image acquired, in which to detect a vehicle located diagonally behind by using a discriminator for detecting a front of a vehicle, and detects a vehicle from within the area; a second image recognition unit that extracts, in the image acquired by the image acquisition unit, a plurality of feature points from within an area in which the vehicle detected by the first image recognition unit is present or estimated to be present, detects an optical flow of the feature points, and tracks the vehicle in the image; and a detection signal output unit that, when a vehicle located diagonally behind is detected in the image by the first image recognition unit or the second image recognition unit, outputs a detection signal indicating that the vehicle is detected diagonally behind to a user interface for notifying a driver that the vehicle is present diagonally behind.

Still another embodiment relates to a vehicle detection method. The method comprises: acquiring an image input from an imaging device mounted to a vehicle and capable of imaging a scene diagonally behind the vehicle; searching an area, in the image acquired, in which to detect a vehicle located diagonally behind by using a discriminator for detecting a front of a vehicle, and detecting a vehicle from within the area; extracting, in the image acquired, a plurality of feature points from within an area in which the vehicle detected is present or estimated to be present in said searching and detecting, detecting an optical flow of the feature points, and tracking the vehicle in the image; and when a vehicle located diagonally behind is detected in said searching and detecting or in said extracting, detecting, and tracking, outputting a detection signal indicating that the vehicle is detected diagonally behind to a user interface for notifying a driver that the vehicle is present diagonally behind.

Optional combinations of the aforementioned constituting elements, and implementations of the embodiment in the form of methods, apparatuses, and systems may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows an example of a field angle of a back camera mounted on a rear part of a vehicle;

FIG. 2 shows an example of image (long distance) of a vehicle diagonally behind captured by the back camera;

FIG. 3 shows an example of image (middle distance) of a vehicle diagonally behind captured by the back camera;

FIG. 4 shows an example of image (short distance) of a vehicle diagonally behind captured by the back camera;

FIGS. 5A, 5B and 5C show other examples of images of the vehicle diagonally behind captured by the back camera;

FIG. 6 shows a vehicle detection device according to an embodiment of the present invention;

FIG. 7 is a flowchart showing an exemplary operation of the vehicle detection device according to the embodiment of the present invention;

FIG. 8 is an exemplary image captured by the back camera when the vehicle diagonally behind is detected;

FIG. 9 is an exemplary image (No. 1) captured by the back camera for detection and determination on the vehicle diagonally behind;

FIG. 10 is an exemplary image (No. 2) captured by the back camera for detection and determination on the vehicle diagonally behind;

FIG. 11 is an exemplary image (No. 3) captured by the back camera for detection and determination on the vehicle diagonally behind;

FIG. 12 is an exemplary image (No. 4) captured by the back camera for detection and determination on the vehicle diagonally behind;

FIG. 13 is a flowchart showing an exemplary process for detection and determination on a vehicle diagonally behind;

FIG. 14 shows an exemplary frame image captured by the back camera subsequent to a frame image in which a determination is made to start tracking the vehicle diagonally behind;

FIG. 15 shows an exemplary image (No. 1) captured by the back camera after the vehicle diagonally behind is started to be tracked;

FIG. 16 shows an exemplary image (No. 2) captured by the back camera after the vehicle diagonally behind is started to be tracked;

FIG. 17 shows an exemplary image (No. 3) captured by the back camera after the vehicle diagonally behind is started to be tracked;

FIG. 18 shows an exemplary image (No. 4) captured by the back camera after the vehicle diagonally behind is started to be tracked;

FIG. 19 shows an exemplary image (No. 5) captured by the back camera after the vehicle diagonally behind is started to be tracked; and

FIG. 20 shows an exemplary image (No. 6) captured by the back camera after the vehicle diagonally behind is started to be tracked.

### DETAILED DESCRIPTION OF THE INVENTION

The invention will now be described by reference to the preferred embodiments. This does not intend to limit the scope of the present invention, but to exemplify the invention.

An embodiment of the present invention relates to a process of monitoring and detecting a vehicle diagonally behind by using a back camera. Three types of representative methods are available to monitor and detect a vehicle diagonally behind.

(1) Method of monitoring and detecting a vehicle diagonally behind by a radar mounted on either side of a vehicle.
(2) Method of monitoring and detecting a vehicle diagonally behind by a side camera mounted on either side of a vehicle.
(3) Method of monitoring and detecting a vehicle diagonally behind by a back camera mounted on a rear part of a vehicle.

Of these, (2) and (3) are of a type that detects a vehicle diagonally behind in an image, and (3) is more competitive in respect of the hardware cost because it can be configured with a single camera.

In order to detect a vehicle diagonally behind on either side by a single back camera, a wide-angle camera having as large a field angle as possible (camera with a horizontal field angle of close to 180°) need be employed. A drawback of a wide-angle camera is that distortion grows toward the left end and right end of the screen. In a scene where a vehicle diagonally behind overtakes the driver's vehicle from behind, distortion of the vehicle diagonally behind increases as it approaches an end of the screen. In addition, a large change in the way that the vehicle diagonally behind appears makes it difficult to detect and track the vehicle by image processing.

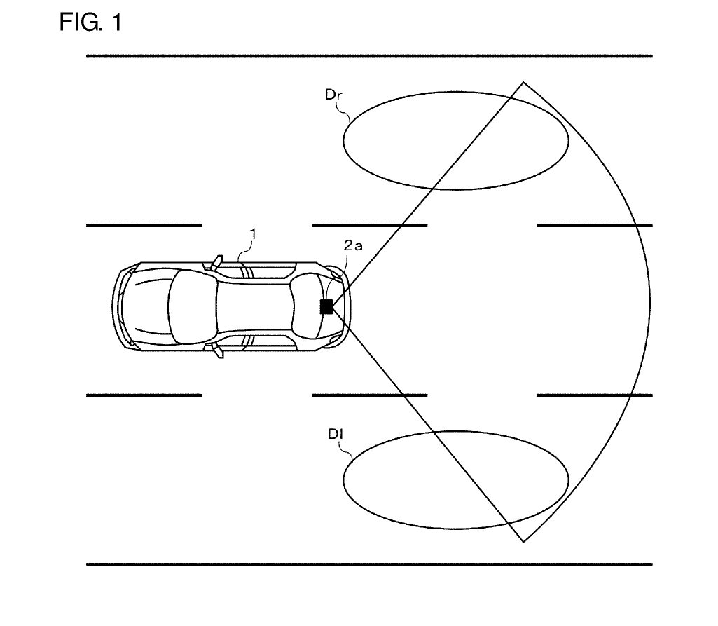

FIG. 1 shows an example of field angle of a back camera 2a mounted on a rear part of a vehicle 1. As shown in FIG. 1, dead zones Dr, Dl that are difficult for the driver to see by a door mirror or a room mirror are located to the rear right and to the rear left of the vehicle 1. An attempt by the driver to change the lane, unaware of another vehicle (vehicle diagonally behind) in the dead zone Dr or Dl, is dangerous. The embodiment addresses this by introducing a scheme of notifying, when a vehicle diagonally behind is captured by the back camera 2a as being located in an adjacent lane, the driver of the presence of the vehicle diagonally behind by a screen display or sound.

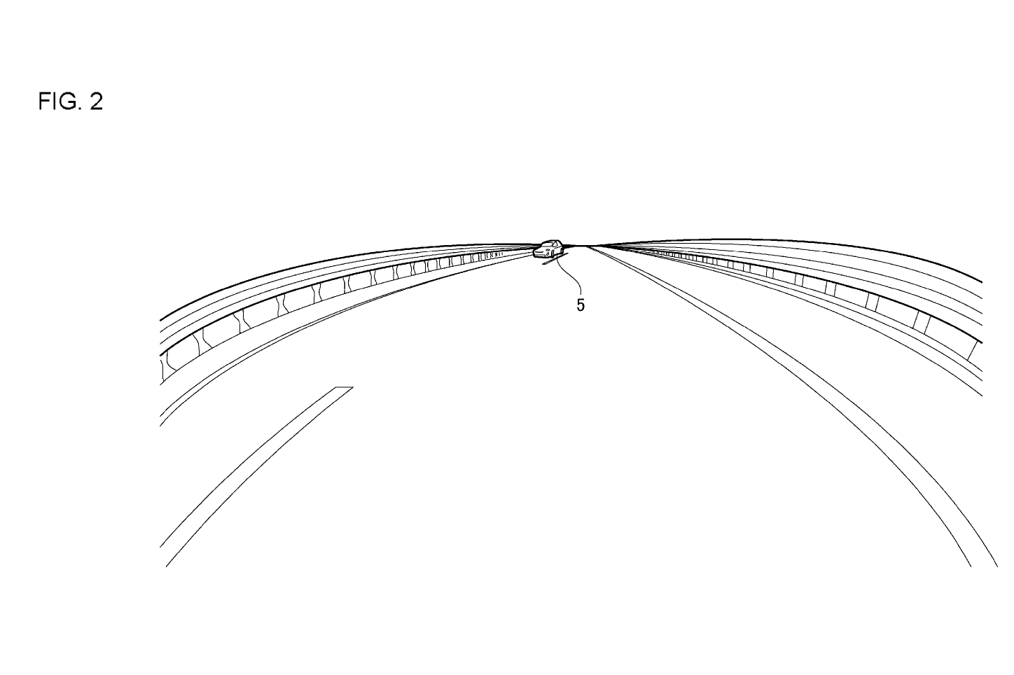

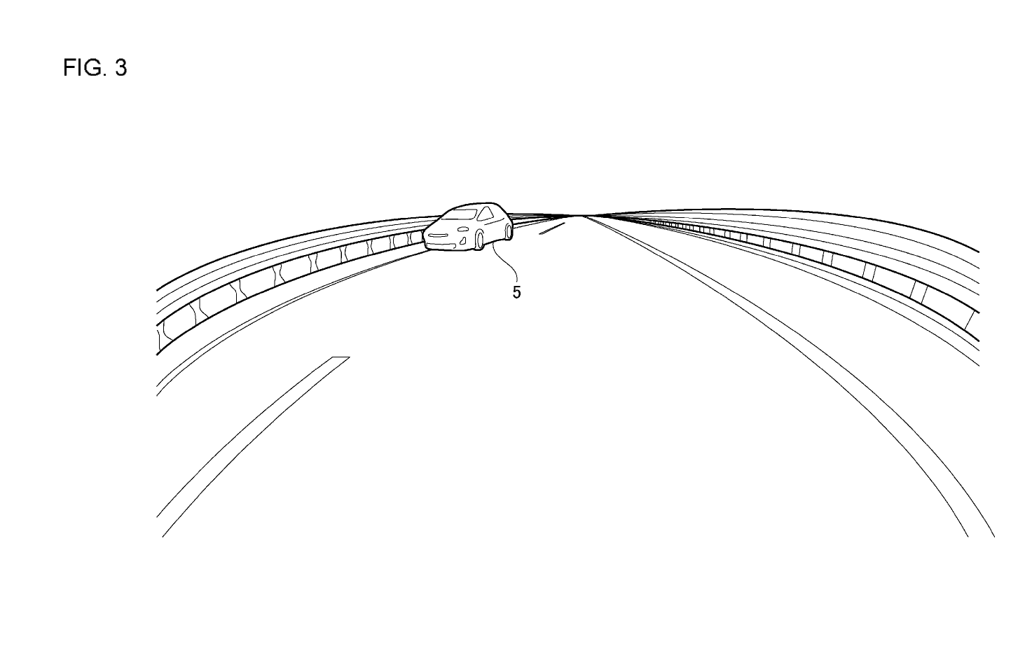

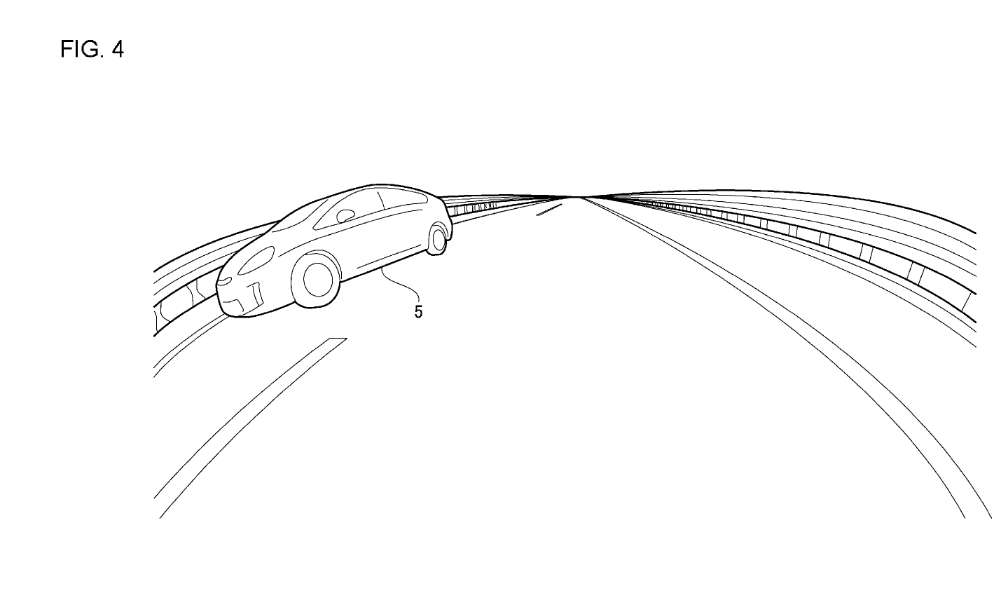

FIG. 2 shows an example of image (long distance) of a vehicle 5 diagonally behind captured by the back camera 2a. FIG. 3 shows an example of image (middle distance) of a vehicle 5 diagonally behind captured by the back camera 2a. FIG. 4 shows an example of image (short distance) of a vehicle 5 diagonally behind captured by the back camera 2a. Referring to FIGS. 2 through 4, the vehicle 5 diagonally behind appears facing front first and changes to facing sideways as the vehicle 5 diagonally behind approaches the driver's vehicle.

One conceivable approach to address this is to use a plurality of discriminators (alternatively, detectors or classifiers) in combination, including a discriminator for a vehicle facing front, a discriminator for a vehicle facing diagonally, and a discriminator for a vehicle facing sideways. This will, however, increase the computational volume and require high-specification hardware resources and results in an increase in the cost.

The embodiment addresses this by detecting a vehicle diagonally behind by using a discriminator for front-facing vehicles, and, thereafter, acquiring a feature point of the vehicle diagonally behind and tracking the movement of the vehicle diagonally behind by using an optical flow of the feature point. This allows detecting a vehicle facing diagonally and a vehicle facing sideways without using a discriminator for vehicles facing diagonally and a discriminator for vehicles facing sideways.

However, tracking by an optical flow is not a universal solution and cannot determine the destination of a feature point accurately without exception. Further, it is difficult to capture a feature point once it has disappeared from the screen by an optical flow. In an exemplary case where the driver's vehicle accelerates when the vehicle diagonally behind has half disappeared from the screen and the vehicle diagonally behind is captured in the screen again, it is difficult to continue to detect the vehicle diagonally behind by an optical flow in a stable manner.

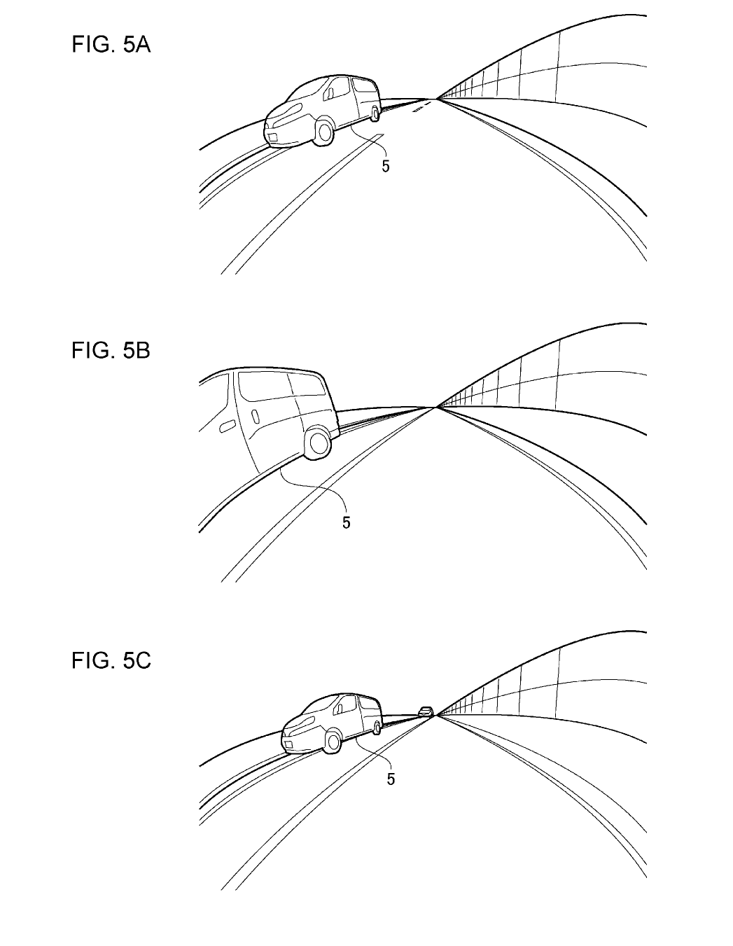

FIGS. 5A-5C show other examples of images of the vehicle 5 diagonally behind captured by the back camera 2a. FIG. 5A shows how the vehicle 5 diagonally behind is approaching the driver's vehicle. FIG. 5B shows how the vehicle 5 diagonally behind is further approaching the driver's vehicle and a front part of the vehicle 5 diagonally behind is outside the field angle of the back camera 2a. FIG. 5C shows that the vehicles are distanced again due to the deceleration of the vehicle 5 diagonally behind and/or the acceleration of the driver's vehicle and the entirety of the vehicle 5 diagonally behind is covered by the field angle of the back camera 2a. In an extreme case, the vehicle 5 diagonally behind is completely outside the field angle of the back camera 2a and then the vehicle 5 diagonally behind recedes relatively to reach a position covered by the field angle of the back camera 2a again. In such a case, it is difficult to continue to detect the vehicle diagonally behind by an optical flow in a stable manner. This is addressed by this embodiment by introducing a scheme to improve the precision in tracking a vehicle by an optical flow.

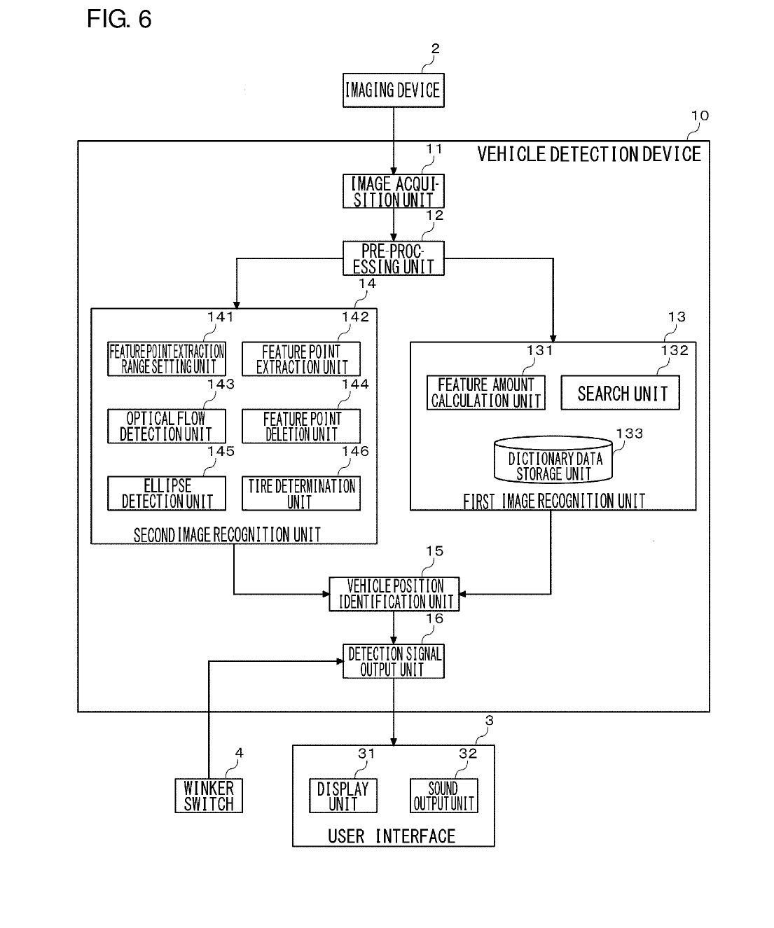

FIG. 6 shows a vehicle detection device 10 according to an embodiment of the present invention. The vehicle detection device 10 includes an image acquisition unit 11, a pre-processing unit 12, a first image recognition unit 13, a second image recognition unit 14, a vehicle position identification unit 15, and a detection signal output unit 16. The first image recognition unit 13 includes a feature amount calculation unit 131, a search unit 132, and a dictionary data storage unit 133. The second image recognition unit 14 includes a feature point extraction range setting unit 141, a feature point extraction unit 142, an optical flow detection unit 143, a feature point deletion unit 144, an ellipse detection unit 145, and a tire determination unit 146. These functional blocks can be implemented by coordination of hardware resources and software resources or hardware resources alone. Processors, ROMs, RAMs, FPGAs, and other LSIs can be used as hardware resources. Programs like operating systems, applications, etc. can be used as software resources.

An imaging device 2 is mounted to the vehicle 1 and is implemented by a camera capable of imaging a scene diagonally behind the vehicle 1. The imaging device 2 corresponds to the back camera 2a. The imaging device 2 includes a solid-state image sensing device and a signal processing circuit (not shown). The solid-state image sensing device comprises a CMOS image sensor or a CCD image sensor and converts an incident light into an electrical image signal. The signal processing circuit subjects the image signal output from the solid-state image sensing device to image processing such as A/D conversion, noise rejection, etc. and outputs the resultant signal to the vehicle detection device 10.

The image acquisition unit 11 acquires the image signal input from the imaging device 2 and delivers the acquired signal to the pre-processing unit 12. The pre-processing unit 12 subjects the image signal acquired by the image acquisition unit 11 to a predetermined pre-process and supplies the pre-processed signal to the first image recognition unit 13 and the second image recognition unit 14. Specific examples of the pre-process will be described later.

The first image recognition unit 13 searches an area in an input image in which to detect a vehicle diagonally behind (hereinafter, referred to as vehicle detection area) by using a discriminator for detecting a vehicle front, and detects a vehicle from within the vehicle detection area. The vehicle detection area is configured to be an area in which the vehicle diagonally behind is captured in the field angle of the imaging device 2, based on the installation position and orientation of the imaging device 2. Specific examples of the vehicle detection area will be described later.

The feature amount calculation unit 131 calculates a feature amount in the vehicle detection area. Haar-like feature amount, Histogram of Gradients (HOG) feature amount, Local Binary Patterns (LBP) feature amount, etc. can be used as the feature amount. The dictionary data storage unit 133 stores a discriminator for vehicle front generated by machine learning a large number images of vehicle front and a large number of images of non-vehicle front. The search unit 132 searches the vehicle detection area by using the discriminator for vehicle front and detects a vehicle in the vehicle detection area.

The second image recognition unit 14 extracts a plurality of feature points from within an area in the input image in which the vehicle detected by the first image recognition unit 13 is present or estimated to be present. The second image recognition unit 14 detects an optical flow of the feature points and tracks the vehicle in the input image.

The feature point extraction range setting unit 141 sets a range in the input image in which a feature point is extracted. Specific examples of the feature point extraction range will be described later. The feature point extraction unit 142 extracts a feature point from the feature point extraction range thus set. A corner detected by the Harris corner detection algorithm may be used as the feature point. The optical flow detection unit 143 detects an optical flow of the extracted feature point. An optical flow is a motion vector showing the motion of a point in an image (the extracted feature point, in the case of the embodiment). An optical flow may be calculated by using, for example, the gradient method or the Lucas-Kanade method.

Of the feature points for which an optical flow is detected, the feature point deletion unit 144 deletes those feature points not corresponding to the direction of movement of the vehicle being tracked from the feature points of the vehicle. For example, feature point detection unit 144 calculates an average of optical flows of a plurality of feature points and deletes feature points of optical flows with a gap equal to or greater than a preset value from the average. As a result, feature points moving in a direction opposite to the direction of movement of the vehicle are identified as feature points of the background and so are deleted. Further, of the feature points present in an immediately preceding frame image, the feature point deletion unit 144 deletes feature points that could not be tracked in the current frame image. There are cases in which the feature point cannot be detected any longer because of a change in the way that the vehicle is illuminated by light or a change in the way that the vehicle appears.

The ellipse detection unit 145 detects an ellipse in an ellipse detection area in the input image. For example, the ellipse detection unit 145 detects an ellipse by ellipse fitting. The ellipse detection area is configured to be an area in which a tire of the vehicle diagonally behind is captured in the field angle of the imaging device 2, based on the installation position and orientation of the imaging device 2. The tire determination unit 146 determines whether the ellipse detected by the ellipse detection unit 145 represents a tire of the vehicle being tracked.

The feature point extraction range setting unit 141 sets, in the input image, a feature point extraction range in the tire of the detected vehicle being tracked and in a neighboring area. When both the front wheel tire and rear wheel tire of the vehicle being tracked are detected, the feature point extraction range setting unit 141 sets, in the input image, a feature point extraction range in the front wheel tire and an area neighboring the front wheel tire, in the rear wheel tire and an area neighboring the rear wheel tire, and in an area between an area neighboring the front wheel and an area neighboring the rear wheel. The feature point extraction unit 142 extracts a feature point from the feature point extraction range thus set and adds the extracted feature point to the feature points of the vehicle being tracked.

The vehicle position identification unit 15 acquires a result of detecting the vehicle from the first image recognition unit 13 and the second image recognition unit 14 and identifies the position of the vehicle in the image. When the position of the vehicle identified is included in the neighborhood of the dead zone to the rear right of the driver's vehicle, the vehicle position identification unit 15 supplies a detection signal indicating a vehicle to the rear right to the detection signal output unit 16. When the position of the vehicle identified is included in the neighborhood of the dead zone to the rear left of the driver's vehicle, the vehicle position identification unit 15 supplies a detection signal indicating a vehicle to the rear left to the detection signal output unit 16.

The detection signal output unit 16 outputs the detection signal indicating a vehicle to the rear right or the detection signal indicating a vehicle to the rear left supplied from the vehicle position identification unit 15 to a user interface 3. The user interface 3 is an interface for notifying the driver of the presence of a vehicle to the rear right or to the rear left. The user interface 3 includes a display unit 31 and a sound output unit 32.

The display unit 31 may be able to display an icon or an indicator and may be a monitor such as a liquid crystal display or an organic EL display. Alternatively, the display unit 31 may be an LED lamp or the like. For example, the display unit 31 may be installed in the door mirror on the right side, and an icon indicating the presence of a vehicle to the rear right may be displayed on the display unit 31 when the detection signal indicating a vehicle to the rear right is input to the display unit 31 from the detection signal output unit 16. The same is true of the door mirror on the left side. Alternatively, an icon indicating the presence of a vehicle to the rear right or a vehicle to the rear left may be displayed on a meter panel or a head-up display. The sound output unit 32 is provided with a speaker. When the detection signal indicating a vehicle to the right rear or a vehicle to the rear left is input to the speaker, the speaker outputs a message or an alert sound indicating the presence of the vehicle to the rear right or the vehicle to the rear left.

The detection signal output unit 16 acquires user control information of a winker switch 4 via an intra-vehicle network (e.g., a CAN bus). When the detection signal indicating a vehicle to the rear right is supplied from the vehicle position identification unit 15, the detection signal output unit 16 outputs the detection signal indicating a vehicle to the rear right to the display unit 31. When the user control information indicating ON is acquired from the right winker switch 4, the detection signal output unit 16 further outputs the detection signal indicating a vehicle to the rear right to the sound output unit 32. This is an example of control whereby, when the detection signal output unit 16 receives a detection signal indicating a vehicle diagonally behind from the vehicle position identification unit 15, the detection signal is output to the display unit 31 unconditionally, and the detection signal is output to the sound output unit 32 on the condition that the winker switch 4 in the direction that the vehicle 5 diagonally behind is detected is turned on. Alternatively, the detection signal may be output to the sound output unit 32 unconditionally.

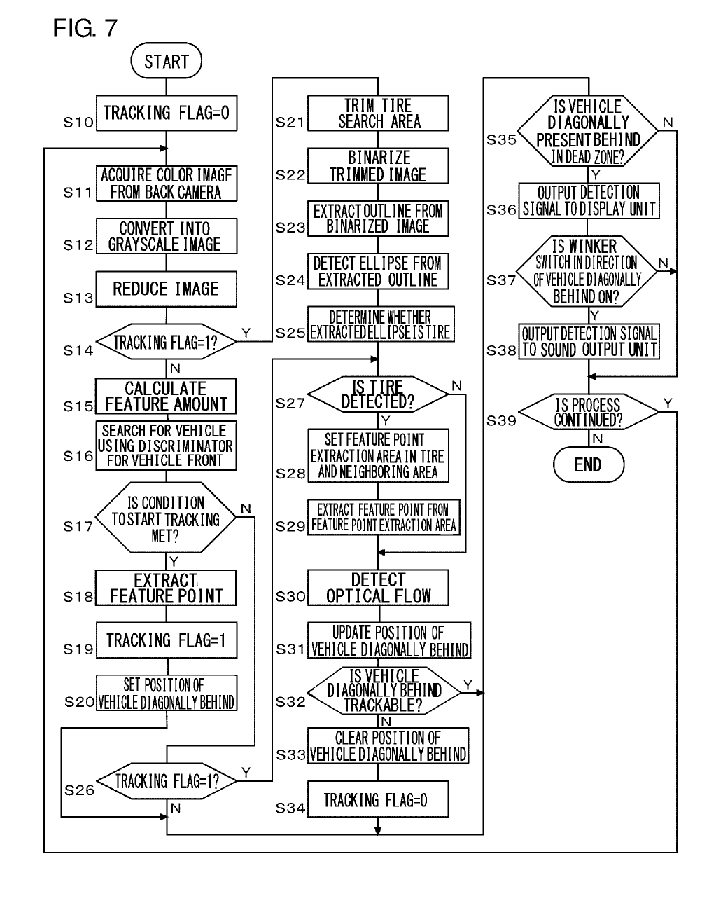

FIG. 7 is a flowchart showing an exemplary operation of the vehicle detection device 10 according to the embodiment of the present invention. In the exemplary operation described below, it is assumed that the back camera 2a captures an image behind the driver's vehicle at a frame rate of 30 Hz.

First, the vehicle position identification unit 15 sets “0” as an initial value of a tracking flag (S10). The tracking flag assumes a value of “0” or “1”, “0” indicating that a vehicle diagonally behind is not being tracked, and “1” indicating that a vehicle diagonally behind is being tracked.

The image acquisition unit 11 acquires a color frame image from the back camera 2a (S11). The pre-processing unit 12 converts the color frame image into a grayscale frame image described only in luminance information (S12). Subsequently, the pre-processing unit 12 reduces the image size by skipping pixels in the grayscale frame image (S13). For example, the pre-processing unit 12 reduces an image of 640×480 pixels to an image of 320×240 pixels. Reduction of an image size is directed to the purpose of reducing the computational volume so that the reduction process in step S13 is skipped when the hardware resources has a high performance specification.

When the value of the tracking flag is “0” (N in S14), the feature amount calculation unit 131 calculates the feature amount of the vehicle detection area in the pre-processed frame image (S15). The search unit 132 searches the vehicle detection area to determine whether a vehicle diagonally behind is present, by using the discriminator for vehicle front (S16).

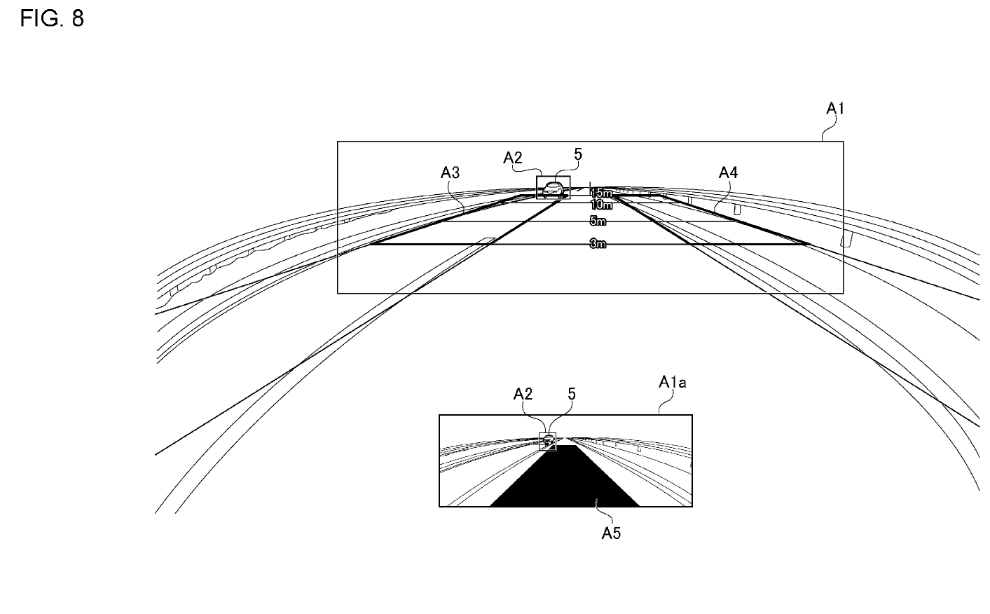

FIG. 8 is an exemplary image captured by the back camera 2a when the vehicle 5 diagonally behind is detected. A vehicle detection area A1 is set in the image shown in FIG. 8. The first image recognition unit 13 detects the vehicle 5 diagonally behind in the vehicle detection area A1. FIG. 8 shows that the vehicle 5 diagonally behind detected by the discriminator for vehicle front is surrounded by a detection frame A2. A rear right vehicle detection area A3 is set in the lane adjacent to the driver's vehicle to the right and in a range at a predetermined distance from the driver's vehicle (3˜15 m from the driver's vehicle in FIG. 8). A rear left vehicle detection area A4 is set in the lane adjacent to the driver's vehicle to the left and in a range at a predetermined distance from the driver's vehicle (3˜15 m from the driver's vehicle in FIG. 8). FIG. 8 shows that the rear left vehicle detection area A4 is set on the road shoulder instead of in the lane adjacent to the left.

A worked image A1a of the vehicle detection area A1 is superimposed toward the bottom of the image shown in FIG. 8. As shown in the worked image A1a, the area of the lane where the driver's vehicle is positioned is defined as an area A5 not subject to detection in order to exclude following vehicles on the same lane as the driver's vehicle from detection. The search unit 132 excludes the area A5 not subject to detection from the search range or deals any vehicle detected in the area A5 not subject detection as an invalid object that does not qualify as a vehicle diagonally behind. When the central position of the detected vehicle is not positioned in the range of the lane adjacent to the right (see the arrow) or the range of the lane adjacent to the left, the search unit 132 also deals the detected vehicle as an invalid object that does not qualify as a vehicle diagonally behind.

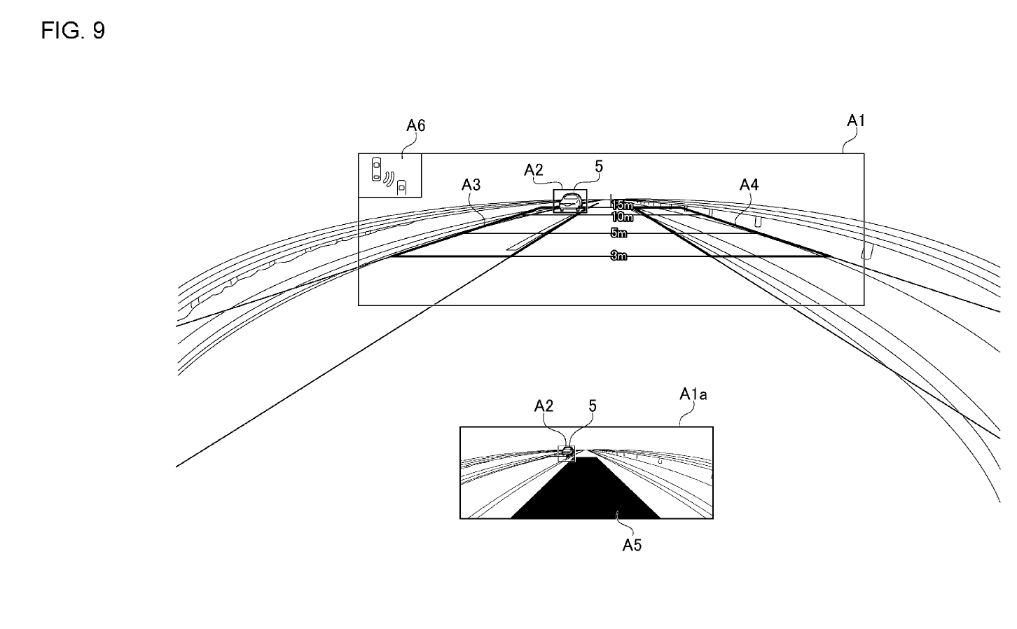

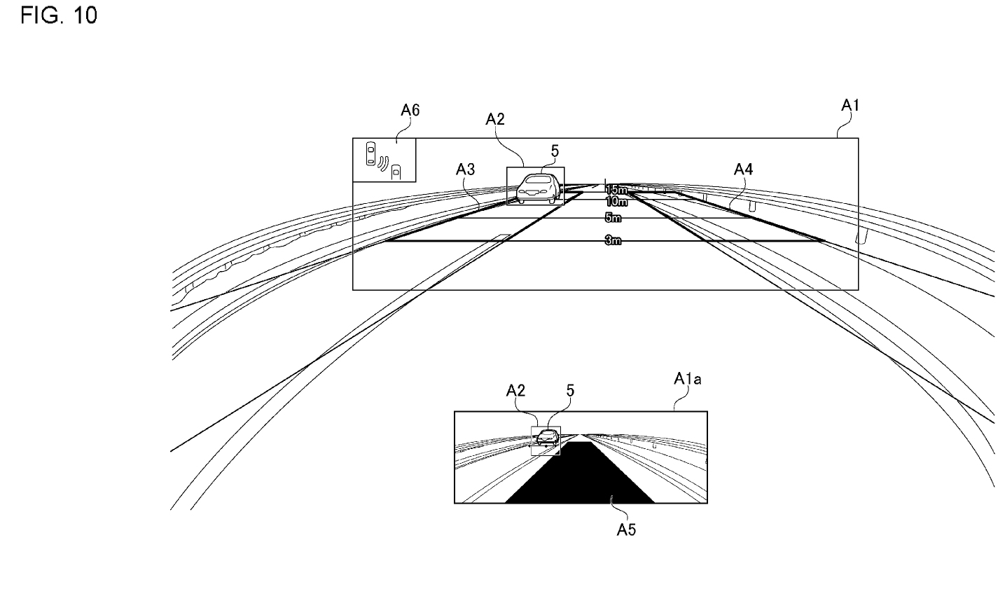

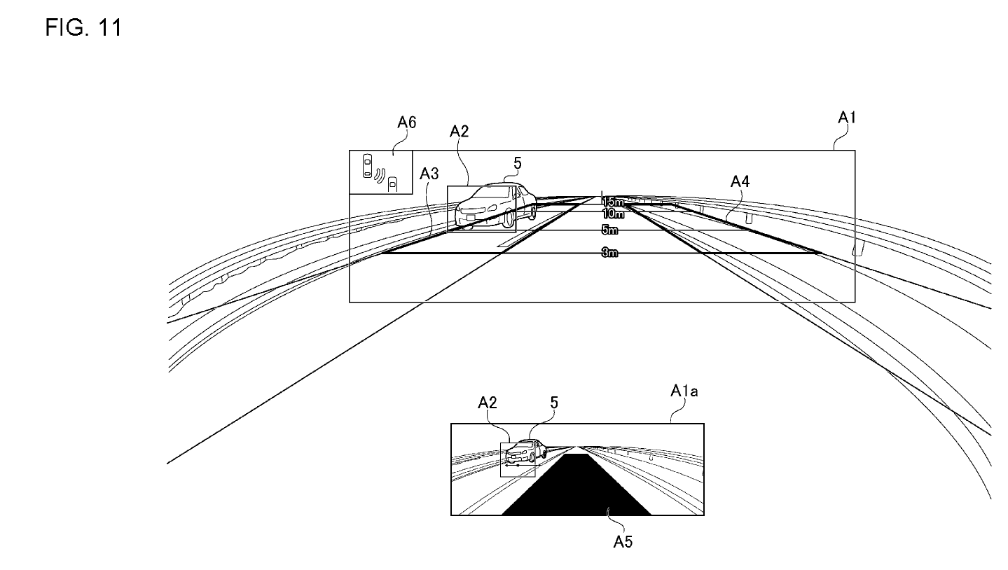

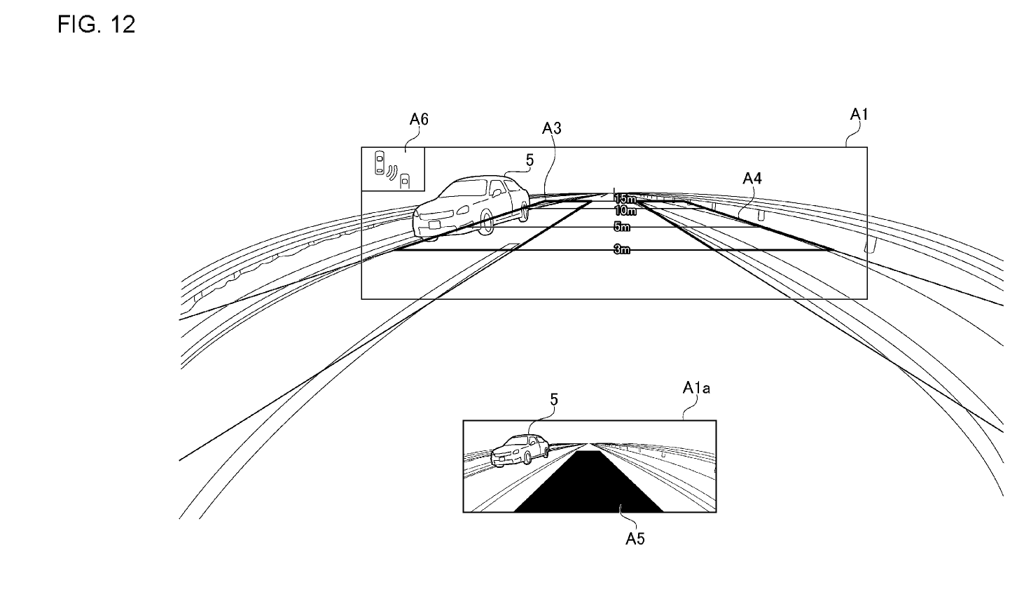

FIG. 9 is an exemplary image (No. 1) captured by the back camera 2a for detection and determination on the vehicle 5 diagonally behind. FIG. 10 is an exemplary image (No. 2) captured by the back camera 2a for detection and determination on the vehicle 5 diagonally behind. FIG. 11 is an exemplary image (No. 3) captured by the back camera 2a for detection and determination on the vehicle 5 diagonally behind. FIG. 12 is an exemplary image (No. 4) captured by the back camera 2a for detection and determination on the vehicle 5 diagonally behind.

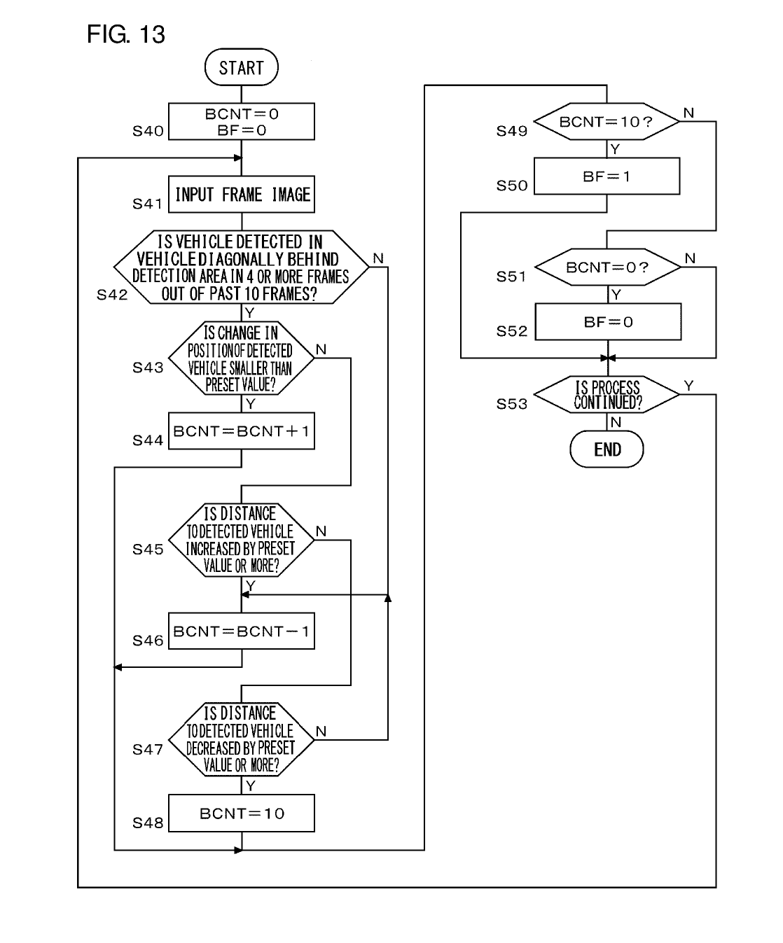

FIG. 13 is a flowchart showing an exemplary process for detection and determination on a vehicle 5 diagonally behind. First, the vehicle position identification unit 15 sets a vehicle diagonally behind detection counter BCNT and a vehicle diagonally behind detection flag BF to an initial value of “0” (S40). The vehicle diagonally behind detection counter BCNT is a work counter that has a minimum value of “0” and a maximum value of “10” and is incremented or decremented by 1. The vehicle diagonally behind detection flag BF assumes a value of “0” or “1”, “0” indicating that a vehicle diagonally behind is not being detected and “1” indicating that a vehicle diagonally behind is being detected.

A new frame image is input to the first image recognition unit 13 (S41). The vehicle position identification unit 15 determines whether the first image recognition unit 13 has detected a vehicle in the rear right vehicle detection area A3 or the rear left vehicle detection area A4 in a predetermined proportion or more of a given number of past frames. In the example shown in FIG. 13, the vehicle position identification unit 15 determines whether the vehicle is detected in four frames or more in the past ten frames (S42). When the vehicle is detected (Y in S42), the vehicle position identification unit 15 determines whether a change in the position of the vehicle detected in the past ten frames is smaller than a first preset value (S43). When the change is smaller than the first preset value (Y in S43), the vehicle position identification unit 15 increments the vehicle diagonally behind detection counter BCNT (S44). When the detected vehicle is approaching the driver's vehicle slowly or when the distance between the detected vehicle and the driver's vehicle is maintained substantially constant, the determination condition of step S43 is met.

When the change in the position of the vehicle detected in the past ten frames is equal to greater than the first preset value (N in S43), the vehicle position identification unit 15 determines whether the distance between the detected vehicle and the driver's vehicle is increased by a second preset value or more in the past ten frames (S45). When the distance is increased by the second preset value or more (Y in S45), the vehicle position identification unit 15 decrements the vehicle diagonally behind detection counter BCNT (S46). When the relative speed of the detected vehicle drops and the detected vehicle is receding from the driver's vehicle, the determination condition of step S45 is met.

When the distance between the detected vehicle and the driver's vehicle is not increased by the second preset value or more in the past ten frames (N in S45), the vehicle position identification unit 15 determines whether the distance between the detected vehicle and the driver's vehicle is reduced by a third preset value or more (S47). When the distance is reduced by the third preset value or more (Y in S47), the vehicle position identification unit 15 sets the vehicle diagonally behind detection counter BCNT to “10” (S48). When the relative speed of the detected vehicle increases and the detected vehicle is approaching the driver's vehicle quickly, the determination condition of step S47 is met.

When the vehicle is not detected in four or more frames in the past ten frames in step S42 (N in S42), or when the distance between the detected vehicle and the driver's vehicle is not reduced by the third preset value or more in step S47 (N in S47), the vehicle position identification unit 15 decrements the vehicle diagonally behind detection counter BCNT (S46).

The vehicle position identification unit 15 refers to the value of the vehicle diagonally behind detection counter BCNT (S49, S51). When the value of the vehicle diagonally behind counter BCNT is “10” (Y in S49), the vehicle position identification unit 15 sets “1” in the vehicle diagonally behind detection flag BF (S50). When the value of the vehicle diagonally behind detection counter BCNT is “0” (N in S49, Y in S51), the vehicle position identification unit 15 sets “0” in the vehicle diagonally behind detection flag BF (S52). When the value of the vehicle diagonally behind detection counter BCNT is one of “1”-“9” (N in S49, N in S51), the vehicle position identification unit 15 maintains the current value of the vehicle diagonally behind detection flag BF. When the process of detecting the vehicle diagonally behind is continued (Y in S53), control is returned to step S41 and steps S41-S52 are repeated. When the process of detecting the vehicle diagonally behind is terminated (N in S53), the process of the flowchart according to FIG. 13 is terminated. The number of past frames that should be referred to, the predetermined proportion, the first preset value, the second preset value, and the third preset value described above in connection with the process for detection and determination on the vehicle 5 diagonally behind according to FIG. 13, are configured by a designer based on experiments, simulation, and various knowledge.

In the image shown in FIG. 9, an icon image A6 rendered on the display unit 31 is superimposed at the top left corner of the vehicle detection area A1. The icon is lighted when the value of the vehicle diagonally behind detection flag BF is “1”. The image shown in FIG. 10 shows that the vehicle 5 diagonally behind approaches nearer the driver's vehicle than in the image shown in FIG. 9. The image shown in FIG. 11 shows that the vehicle 5 diagonally behind approaches still nearer the driver's vehicle. The image shown in FIG. 12 shows that the vehicle 5 diagonally behind approaches still nearer the driver's vehicle. In the image shown in FIG. 12, the vehicle 5 diagonally behind appears diagonal and the discriminator for vehicle front is no longer able to detect the vehicle 5 diagonally behind.

Reference is made back to the flowchart of FIG. 7. The vehicle position identification unit 15 determines whether a condition to start tracking the vehicle 5 diagonally behind is met (S17). For example, the condition to start tracking the vehicle diagonally behind may require that the value of the vehicle diagonally behind detection counter BCNT is decremented from “1” to “0” while the vehicle diagonally behind detection flag BF is “1”. Other conditions (e.g., a condition requiring that the distance between the vehicle 5 diagonally behind and the driver's vehicle is less than 5 m) may be used as the condition to start tracking the vehicle diagonally behind.

When the condition to start tracking the vehicle 5 diagonally behind is met (Y in S17), the feature point extraction range setting unit 141 sets a rectangular feature point extraction range at a position where the vehicle 5 diagonally behind is estimated to be present. The position where the vehicle 5 diagonally behind is estimated to be present in the current frame is determined based on the past position where the vehicle was detected and on a motion vector calculated from a history of movement (direction and speed). The feature point extraction unit 142 extracts a feature point from the feature point extraction range thus set (S18). Extraction of the feature point is performed only once at the time of starting tracking the vehicle. In the subsequent frames, the feature point extracted in this process is tracked by an optical flow. The vehicle position identification unit 15 sets “1” in the tracking flag (S19). The vehicle position identification unit 15 sets the position of the vehicle 5 diagonally behind at the time of starting tracking (S20). Of the plurality of feature points extracted, the position of the vehicle 5 diagonally behind is defined by a rectangular area (hereinafter, referred to as a vehicle tracking area) that passes through all of the feature point at the uppermost position, feature point at the lowermost position, feature point at the leftmost position, and feature point at the right most position. Subsequently, a transition is made to step S35.

When the condition to start tracking the vehicle 5 diagonally behind is not met in step S17 (N in S17), and when the value of the tracking flag is “1” (Y in S26), a transition is made to step S27. When the value of the tracking flag is “0” (N in S26), a transition is made to step S35.

When the value of the tracking flag is determined to be “1” in step S14 (Y in S14), the ellipse detection unit 145 trims an area where the tire of the vehicle 5 diagonally behind located in the lane adjacent to the the right or the lane adjacent to the left is estimated to be shown (hereinafter, tire search area) from the pre-processed frame image (S21). The ellipse detection unit 145 converts the trimmed image into a black-and-white binarized image (S22). The ellipse detection unit 145 extracts an outline from the binarized image (S23). For example, the ellipse detection unit 145 extracts an outline by subjecting the binarized image to high-pass filtering. The ellipse detection unit 145 detects an ellipse by subjecting the extracted outline to ellipse fitting (S24).

The tire determination unit 146 determines whether the detected ellipse represents a tire of the vehicle 5 diagonally behind (S25). For example, an ellipse that meets all of the three following conditions is determined to be a tire.

(1) That the central position of the detected ellipse is located near the position where the tire of the vehicle 5 diagonally behind is estimated to be shown.
(2) That the detected ellipse is not a true circle and is a vertically long ellipse determined by parameters of the back camera 2a.
(3) That the size of the ellipse is within a range of sizes estimated to be those of a tire of the vehicle 5 diagonally behind.

A supplementary description will be given of the condition (2). When a wide angle camera is used as the back camera 2a, an image captured by the back camera 2a is heavily distorted on the left end portion and the right end portion. The distortion makes a tire of the vehicle appear a vertically long ellipse instead of a true circle at the left end portion and the right end portion in the image captured by the back camera 2a. Distortion in the appearance of a tire varies depending on the camera parameters.

When a tire is detected in the process in step S26 (Y in S27), and when the tire detection area surrounding the detected tire by a rectangle and the vehicle tracking area overlap, the feature point extraction range setting unit 141 sets a feature point detection range around the detected tire and the neighboring area (S28). The feature point extraction unit 142 extracts a feature point from the feature point extraction range thus set (S29). The vehicle position identification unit 15 integrates the vehicle tracking area and the tire detection area and combines the feature point extracted in step S29 with the existing feature points in the vehicle tracking area. In the post-integration rectangular area, the vehicle position identification unit 15 extracts a rectangular area corresponding to the lower half of the vehicle 5 diagonally behind estimated from the position of the tire, and sets the extracted area as a new vehicle tracking area. Feature points outside the new vehicle tracking area are deleted and feature points inside the new vehicle tracking area are maintained. This can remove feature points extracted from outside the vehicle such as the backdrop and road surface. The feature point extraction unit 142 may extract a feature point from within the new vehicle tracking area instead of the feature point extraction range set by the feature point extraction range setting unit 141.

In the above description, it is assumed that only one of the front wheel tire and the rear wheel tire is detected. The following steps are performed when both the front wheel tire and the rear wheel tire are detected. The vehicle position identification unit 15 confirms whether a front and rear tire detection area, defined by surrounding a front wheel tire detection area and a rear wheel detection area by a rectangle, and the vehicle tracking area overlap, the front wheel tire detection area being defined by surrounding the front wheel tire by a rectangle, and the rear wheel tire detection area being defined by surrounding the rear wheel tire by a rectangle. If they overlap, the areas are integrated. The feature point extraction unit 142 extracts a feature point from within the front and rear wheel tire detection area. The vehicle position identification unit 15 combines the feature point thus extracted with existing feature points in the vehicle tracking area. In the post-integration rectangular area, the vehicle position identification unit 15 extracts a rectangular area corresponding to the lower half of the vehicle 5 diagonally behind estimated from the position of the tire, and sets the extracted area as a new vehicle tracking area. Feature points outside the new vehicle tracking area are deleted and feature points in the new vehicle tracking area are maintained. The front and rear wheel tire detection area may not be integrated with the vehicle tracking area and may be defined as a new vehicle tracking area unmodified or after being enlarged to a certain degree. In this case, all of the feature points in the previous vehicle tracking area are discarded.

When a tire is not detected in the process in step S26 (N in S27), and when the tire detection area and the vehicle tracking area de not overlap even if a tire is detected, the processes in step S28 and step S29 are skipped.

The optical flow detection unit 143 tracks, in the current frame, the destination of movement of each feature point in the vehicle tracking area in the previous frame, by detecting an optical flow (S30). A plurality of feature points extracted from a vehicle should inherently move in the same direction uniformly in association with the movement of the vehicle. It is determined that feature points that make a movement inconsistent with the uniform movement are not feature points extracted from the vehicle. The feature point deletion unit 144 deletes feature points that make a movement inconsistent with the uniform movement. The feature point deletion unit 144 also deletes feature points for which destinations of movement cannot be identified. The vehicle position identification unit 15 updates the position of the vehicle tracking area based on the feature points at the destinations of movements (S31).

The vehicle position identification unit 15 determines whether the vehicle 5 diagonally behind can be tracked (S32). When it becomes difficult to track the vehicle 5 diagonally behind (e.g., when the vehicle 5 diagonally behind has completely overtaken the driver's vehicle and disappeared entirely outside the screen, or the number of trackable feature points is equal to or fewer than a predetermined value, or a tire cannot be detected and the process of extracting or updating a feature point is not performed for a predetermined period of time or longer), it is determined that tracking is impossible. If it is determined that tracking is impossible (N in S32), the vehicle position identification unit 15 clears the vehicle tracking area (S33). The vehicle position identification unit 15 sets “0” in the tracking flag (S34). The vehicle position identification unit 15 also sets “0” in the vehicle diagonally behind detection flag BF. When it is determined in step S32 that the vehicle 5 diagonally behind is trackable (Y in S32), the processes in step S33 and step S34 are skipped.

The vehicle position identification unit 15 determines whether the vehicle 5 diagonally behind is present in a dead zone of the driver of the driver's vehicle (S35). When either the value of the vehicle diagonally behind detection flag BF is “1” or the value of the tracking flag is “1”, it is determined that the vehicle 5 diagonally behind is present in a dead zone. If it is determined that the vehicle 5 diagonally behind is present in a dead zone (Y in S35), the detection signal output unit 16 outputs a detection signal indicating the vehicle 5 diagonally behind to the display unit 31 and causes the display unit 31 to display an alert. If it is determined that the vehicle 5 diagonally behind is not present in a dead zone (N in S35), a transition is made to step S39.

When the detection signal output unit 16 acquires form the CAN bus a user control signal indicating that the winker switch 4 in the direction in which the vehicle 5 diagonally behind is present is turned on (Y in S37), the detection signal output unit 16 outputs a detection signal indicating the vehicle 5 diagonally behind to the sound output unit 32 and causes the sound output unit 32 to output an alert sound (S38). If the winker switch 4 in the direction that the vehicle 5 diagonally behind is present is turned on, it can be estimated that the driver is not aware of the vehicle 5 diagonally behind so that sound is added to raise the level of alert to the driver. In this manner, it is expected that the driver is restrained from a lane change that entails a risk of colliding with the vehicle 5 diagonally behind. When the user control signal is not acquired (N in S37), the process in step S38 is skipped.

When the process of detecting the vehicle diagonally behind is continued (Y in S39), control is returned to step S11 and steps S11-S38 are repeated. When the process of detecting the vehicle diagonally behind is terminated (N in S39), the process of the flowchart according to FIG. 7 is terminated.

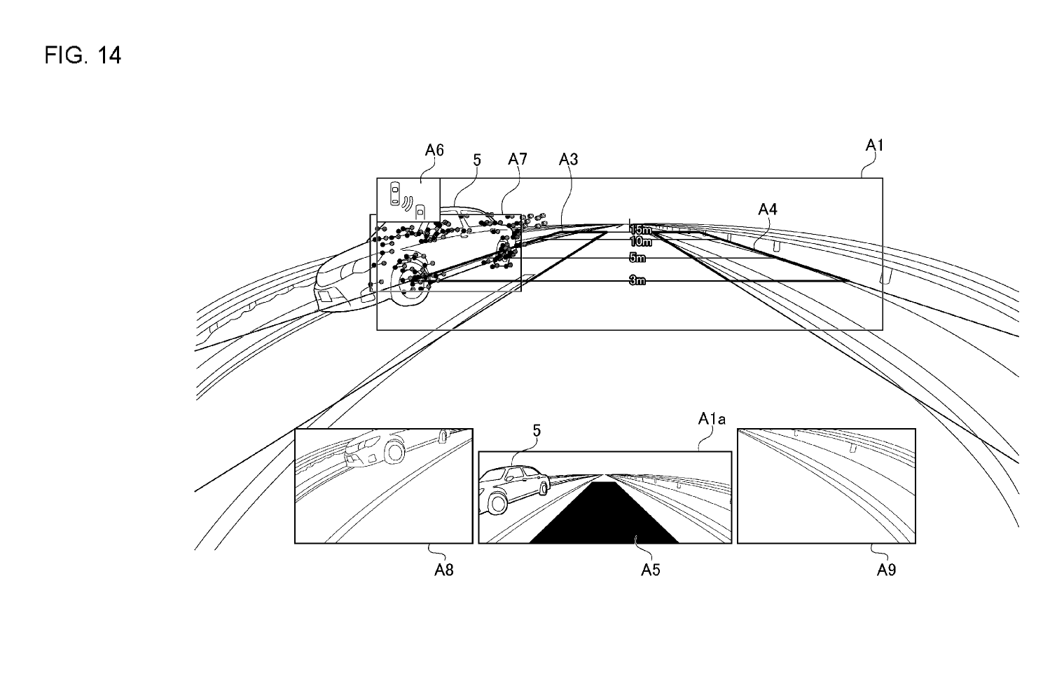

FIG. 14 shows an exemplary frame image captured by the back camera subsequent to a frame image in which a determination is made to start tracking the vehicle diagonally behind. Of a plurality of feature points in the frame image, solid feature points are those detected in the current frame image by an optical flow. Feature points indicated by diagonal lines descending from right to left are those extracted from the previous frame image (frame image occurring when tracking was started). Solid feature points are those at the destinations of movement of the feature points in the previous frame image (feature points indicated by diagonal lines descending from right to left). Feature points indicated by diagonal lines descending from left to right are those moving inconsistently with the direction of movement of the feature points as a whole and so are considered as noise. Feature points that are considered as noise are deleted and will no longer be present in the subsequent frame images.

In the image shown in FIG. 14, a vehicle tracking area A7 defined by surrounding feature points extracted from the previous frame image (feature points indicated by diagonal lines descending from right to left) by a rectangle is set. In the next frame image, the vehicle tracking area A7 is updated to a vehicle tracking area defined by surrounding features points detected in the current frame image by an optical flow by a rectangle (solid feature points).

A worked image A8 of a tire search range for a vehicle to the rear right is superimposed in the bottom left part of the image shown in FIG. 14, and a worked image A9 of a tire search range for a vehicle to the rear left is superimposed in the bottom right part. When the vehicle 5 diagonally behind is started to be tracked, the ellipse detection process by the ellipse detection unit 145 is started. The ellipse detection unit 145 searches the tire search range for a vehicle to the rear right and tire search range for a vehicle to the rear left for an ellipse by ellipse fitting. The image in FIG. 14 shows that an ellipse has not been detected.

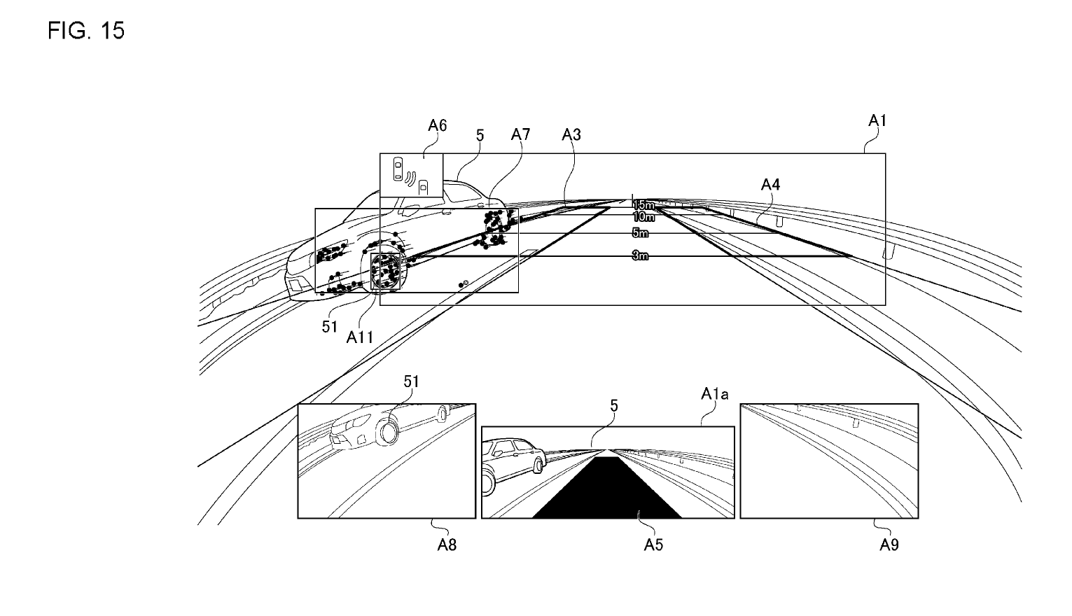

FIG. 15 shows an exemplary image (No. 1) captured by the back camera 2a after the vehicle 5 diagonally behind is started to be tracked. As shown in the worked image A8 of the tire search range of a vehicle to the rear right, a front wheel tire 51 of the vehicle 5 diagonally behind is detected by ellipse fitting. A front wheel tire detection area A11 surrounding the front wheel tire 51 of the vehicle 5 diagonally behind by a rectangle is set.

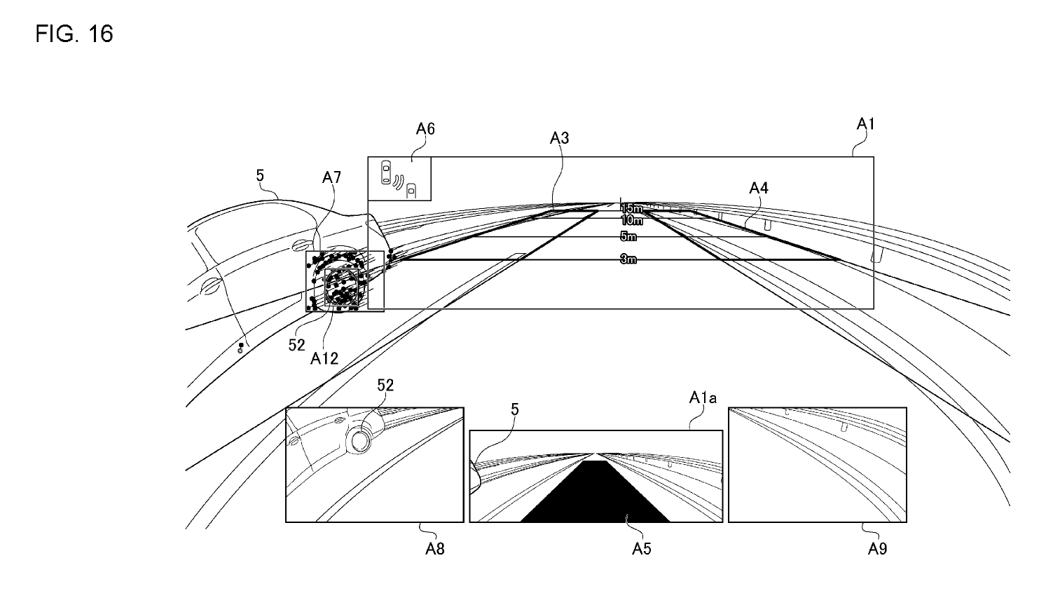

FIG. 16 shows an exemplary image (No. 2) captured by the back camera 2a after the vehicle 5 diagonally behind is started to be tracked. The image in FIG. 16 shows that the vehicle 5 diagonally behind approaches the driver's vehicle and a front part of the vehicle 5 diagonally behind is left outside the image. As shown in the worked image A8 of the tire search range for a vehicle to the rear right, a rear wheel tire 52 of the vehicle 5 diagonally behind is detected by ellipse fitting. A rear wheel tire detection area A12 surrounding the rear wheel tire 52 of the vehicle 5 diagonally behind by a rectangle is set. In the image shown in FIG. 16, feature points other than those in and near the rear wheel tire 52 are already deleted so that the size of the vehicle tracking area A7 is reduced.

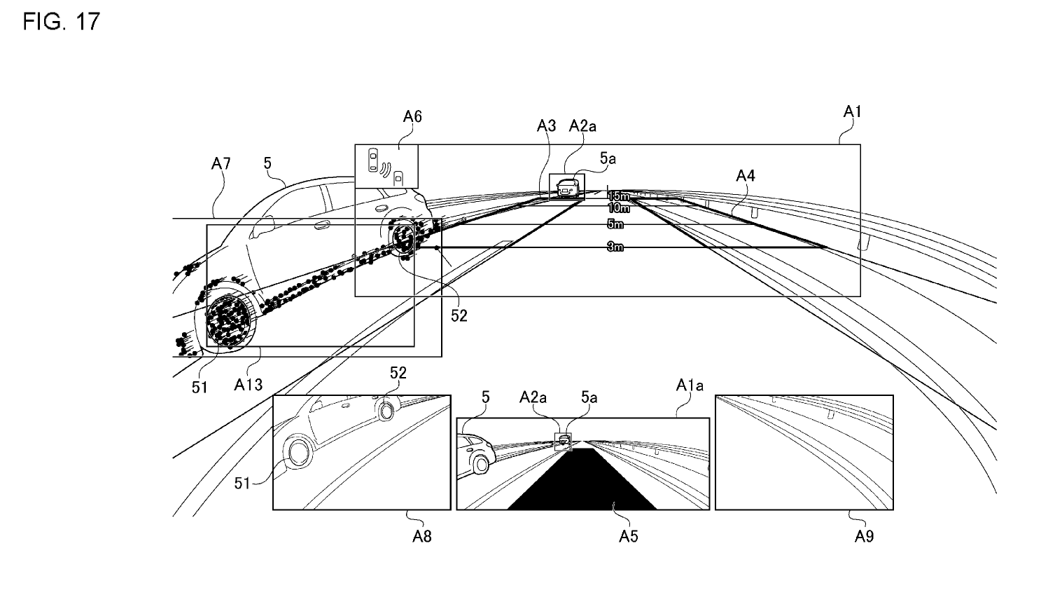

FIG. 17 shows an exemplary image (No. 3) captured by the back camera 2a after the vehicle 5 diagonally behind is started to be tracked. As shown in the worked image A8 of the tire search range for a vehicle to the rear right, both the front wheel tire 51 and the rear wheel tire 52 of the vehicle 5 diagonally behind are detected by ellipse fitting. A front and rear wheel tire detection area A13 surrounding the front wheel tire 51 and the rear wheel tire 52 by a rectangle is set. A vehicle 5a diagonally behind that follows the vehicle 5 diagonally behind is detected in the vehicle detection area A1 by the discriminator for vehicle front and is surrounded by a detection frame A2a.

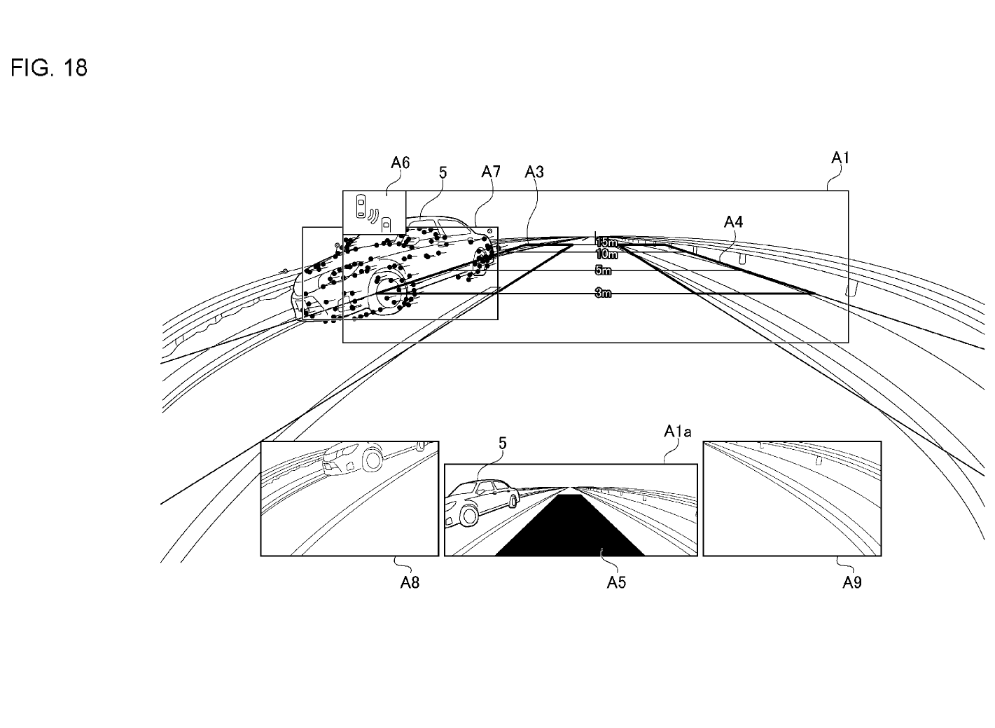

FIG. 18 shows an exemplary image (No. 4) captured by the back camera 2a after the vehicle 5 diagonally behind is started to be tracked. The image shown in FIG. 18 shows that an ellipse has not been detected by the ellipse detection unit 145. While an ellipse is not detected, tracking of feature points by an optical flow and updating the vehicle tracking area A7 are performed.

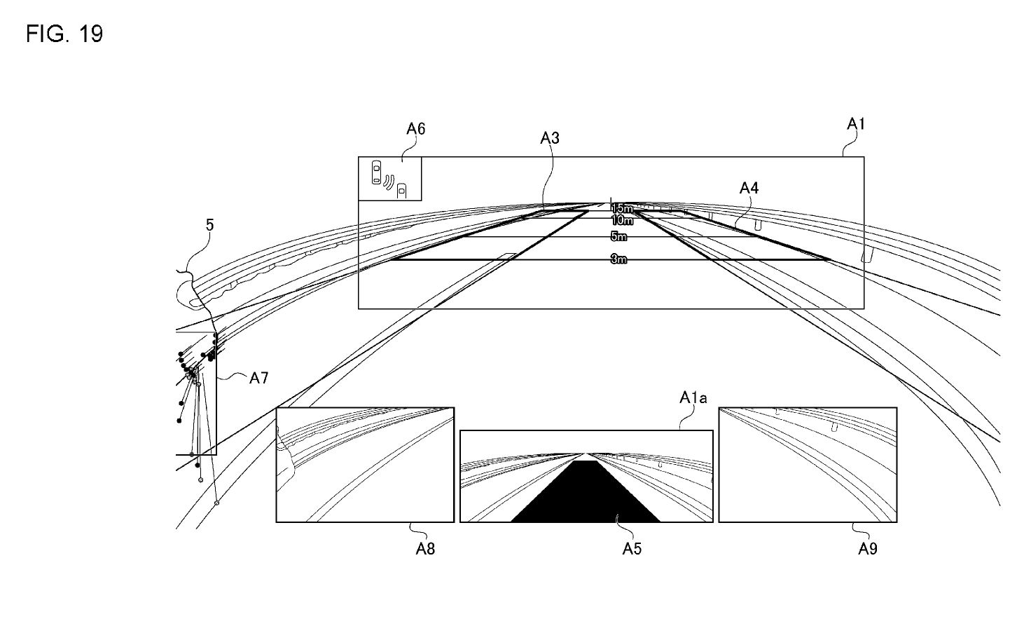

FIG. 19 shows an exemplary image (No. 5) captured by the back camera 2a after the vehicle 5 diagonally behind is started to be tracked. The image in FIG. 19 shows that the vehicle 5 diagonally behind approaches the driver's vehicle and a major portion of the vehicle 5 diagonally behind is left outside the field angle of the back camera 2a.

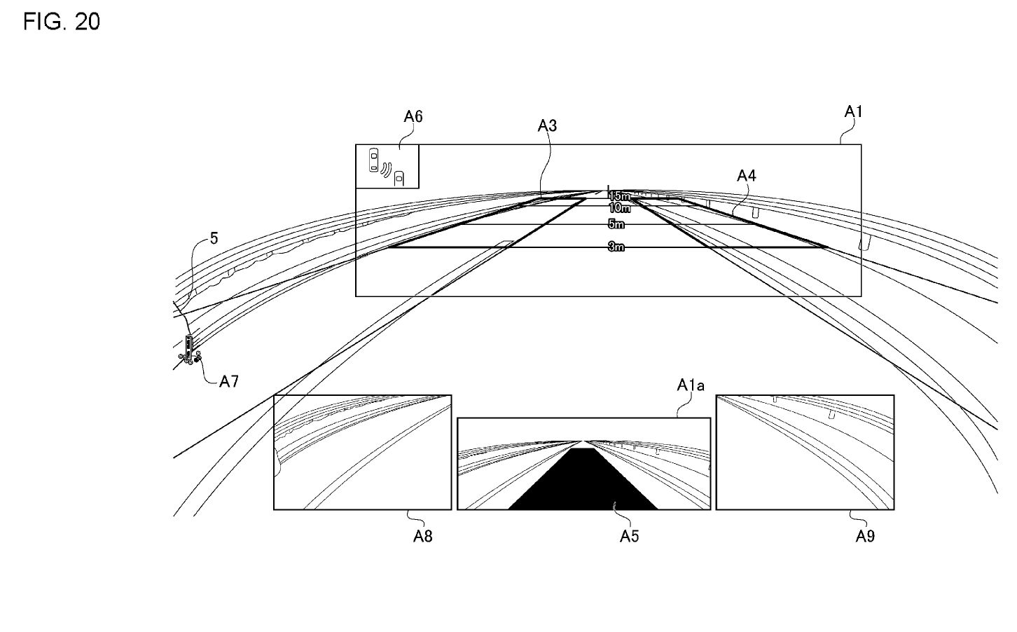

FIG. 20 shows an exemplary image (No. 6) captured by the back camera 2a after the vehicle 5 diagonally behind is started to be tracked. The image in FIG. 20 shows that the vehicle 5 diagonally behind approaches the driver's vehicle and the vehicle 5 diagonally behind is just about to disappear completely from the field angle of the back camera 2a. In this state, the number of feature points is smaller than a predetermined value and it is determined that tracking is impossible. Therefore, the driver is no longer alerted. The driver checks approaching vehicles visually.

As described above, the embodiment enables highly precise detection of a vehicle diagonally behind with reduced cost, by providing a single back camera and using a combination of image recognition of a vehicle diagonally behind by using a discriminator for vehicle front and image recognition of a vehicle diagonally behind by using an optical flow. In essence, the cost is reduced as compared with a case of using two cameras.

The vehicle diagonally behind shown in an image captured by a single back camera changes its appearance significantly depending on the distance to the driver's vehicle. Therefore, attempts to detect a vehicle diagonally behind by using only a discriminator requires constantly checking a plurality of discriminators against each other, with the result that computational volume is increased and the hardware cost is increased. The embodiment addresses this by detecting a vehicle diagonally behind facing the front in the image by using a discriminator and detecting a vehicle facing diagonally and a vehicle facing sideways in a tracking process using an optical flow. This can reduce the computational volume for image recognition of a vehicle diagonally behind using a discriminator. Even allowing for the computational volume for image recognition of a vehicle diagonally behind using an optical flow, the computational volume is reduced as compared with a case of detecting a vehicle diagonally behind only by using a discriminator.

An optical flow is a process to determine a destination of movement of a feature point in an (n−1)th frame image to an n-th frame image. The reliability of an optical flow drops over a time if it continues to be used to track a vehicle for a long period of time. For example, the process may track a feature point of a vehicle properly at first but may end up tracking a feature point of the backdrop at some point in time. Further, it may become difficult to determine the destinations of movement of feature points properly so that the number of feature points that can be subject to tracking may be reduced. Accordingly, the reliability of a vehicle tracking area is high immediately after optical flow based detection is started, but the reliability of a vehicle tracking area drops when a long period of time has elapsed since the start of detection.

In this respect, the embodiment introduces a tire detection process described above. In a tire detection process, feature points in a tire and a neighboring area are extracted and added to the feature points of the vehicle. This ensures that the feature points of the vehicle are updated and the precision of the tracking process based on an optical flow is maintained. The backdrop other than the road surface is not basically shown around a tire so that the likelihood of extracting a false feature point from the backdrop is reduced. In the case of a paved road, the image of the road surface is flat so that it is unlikely that a feature point is extracted from the road surface. Therefore, by extracting feature points in a tire and a neighboring area, the likelihood of extracting noise as a feature point is reduced.

Further, by detecting a vertically long ellipse to detect a tire, the precision of detecting a tire is improved. As described, a tire distorted in an image due to distortion in the camera can be accurately detected. This also prevents a headlight of the vehicle from being determined as a tire in error. Since a head light is a horizontally long ellipse, a headlight is prevented from being detected as a tire in error by detecting a vertically long ellipse.

Described above is an explanation based on an exemplary embodiment. The embodiment is intended to be illustrative only and it will be understood by those skilled in the art that various modifications to constituting elements and processes could be developed and that such modifications are also within the scope of the present invention.

The flowchart of FIG. 7 shows a process of adding a feature point in all of the frame images in which a tire is detected. The system may employ control whereby a feature point is not added even if a tire is detected, provided that a predetermined frame interval (e.g., three frames) is not interposed since the frame to which a feature point was added previously. Continuous addition of feature points to all frame images while a tire is being detected results in numerous overlapping between feature points identified as destinations of movement from the previous frame image in an optical flow and feature points in the current frame image. By providing an interval between frames to which feature points are added, overlapping between feature points can be reduced.

In describing the embodiment, the use of one back camera is assumed. However, the use of a plurality of cameras is not excluded. For example, even when two cameras, including a camera for imaging a scene to the rear right and a camera for imaging a scene to the rear left, are installed on either side of a rear part of a vehicle, the appearance of a vehicle diagonally behind may be similar to that of the examples shown in the embodiment described above, depending on the field angle and orientation of the cameras. In this case, the benefit other than the benefit of reduced camera cost can be enjoyed by using the technology according to the embodiment.

1. A vehicle detection device, comprising:
an image acquisition unit that is mounted to a first vehicle and acquires an image input from an imaging device capable of imaging a scene diagonally behind the first vehicle;
a first image recognition unit that searches an area of the image acquired to detect a second vehicle located diagonally behind the first vehicle by using a discriminator to detect a front of the second vehicle, and detects the second vehicle in the area in the image acquired;
a second image recognition unit that extracts from the image acquired by the image acquisition unit a plurality of feature points from within the area in which the second vehicle detected by the first image recognition unit is present or estimated to be present, detects an optical flow of the plurality of feature points, and tracks the second vehicle in the image; and
a detection signal output unit that, when the second vehicle located diagonally behind the first vehicle is detected in the image by the first image recognition unit or the second image recognition unit, outputs a detection signal indicating that the second vehicle is detected diagonally behind the first vehicle to a user interface for notifying a driver that the second vehicle is presently diagonally behind the first vehicle, wherein:
the second image recognition unit deletes, from the plurality of features points for which the optical flow is detected, a feature point not corresponding to a direction of movement of the second vehicle from the plurality of feature points of the second vehicle,
the second image recognition unit detects, in the image acquired by the image acquisition unit, a tire of the second vehicle being tracked, extracts a feature point in the tire detected and a neighboring area, and adds the feature point extracted to the plurality of feature points of the second vehicle, and
the second image recognition unit detects the tire of the second vehicle by detecting, in the image acquired by the image acquisition unit, a vertically long ellipse in accordance with a parameter of the imaging device.

2. The vehicle detection device according to claim 1, wherein when both a front wheel tire and a rear wheel tire of the second vehicle being tracked are detected, the second image recognition unit extracts, in the image acquired by the image acquisition unit, a first feature point in the front wheel tire and an area neighboring the front wheel tire, a second feature point in the rear wheel tire and an area neighboring the rear wheel tire, and a third feature point in an area between an area neighboring the front wheel and an area neighboring the rear wheel, and adds the first, second, and third feature points extracted to the plurality of feature points of the vehicle.

3. The vehicle detection device according to claim 1, wherein
the imaging device includes a single imaging device capable of imaging a scene to a rear right and to a rear left of the first vehicle.

4. A vehicle detection system, comprising:
an imaging device mounted to a first vehicle and capable of imaging a scene diagonally behind the first vehicle; and
a vehicle detection device communicatively connected to the imaging device, wherein the vehicle detection device includes:
an image acquisition unit that acquires an image input from the imaging device;
a first image recognition unit that searches an area of the image acquired to detect a second vehicle located diagonally behind the first vehicle by using a discriminator to detect a front of the second vehicle, and detects the second vehicle in the area of the image acquired;
a second image recognition unit that extracts from the image acquired by the image acquisition unit a plurality of feature points from within the area in which the second vehicle detected by the first image recognition unit is present or estimated to be present, detects an optical flow of the plurality of feature points, and tracks the second vehicle in the image; and
a detection signal output unit that, when the second vehicle located diagonally behind the first vehicle is detected in the image by the first image recognition unit or the second image recognition unit, outputs a detection signal indicating that the second vehicle is detected diagonally behind the first vehicle to a user interface for notifying a driver that the second vehicle is presently diagonally behind the first vehicle, wherein:
the second image recognition unit deletes, from the plurality of features points for which the optical flow is detected, a feature point not corresponding to a direction of movement of the second vehicle from the plurality of feature points of the second vehicle,
the second image recognition unit detects, in the image acquired by the image acquisition unit, a tire of the second vehicle being tracked, extracts a feature point in the tire detected and a neighboring area, and adds the feature point extracted to the plurality of feature points of the second vehicle, and
the second image recognition unit detects the tire of the second vehicle by detecting, in the image acquired by the image acquisition unit, a vertically long ellipse in accordance with a parameter of the imaging device.

5. A vehicle detection method, comprising:
acquiring an image input from an imaging device mounted to a first vehicle and capable of imaging a scene diagonally behind the first vehicle;
searching an area of the image acquired to detect a second vehicle located diagonally behind the first vehicle by using a discriminator to detect a front of the second vehicle, and detecting the second vehicle in the area of the image acquired;
extracting, from the image acquired, a plurality of feature points from within the area in which the second vehicle detected is present or estimated to be present in the searching and detecting, detecting an optical flow of the plurality of feature points, and tracking the second vehicle in the image; and
when the second vehicle located diagonally behind the first vehicle is detected in the searching and detecting or in the extracting, detecting, and tracking, outputting a detection signal indicating that the second vehicle is detected diagonally behind the first vehicle to a user interface for notifying a driver that the second vehicle is presently diagonally behind the first vehicle, wherein:
the extracting, detecting, and tracking deletes, from the plurality of features points for which the optical flow is detected, a feature point not corresponding to a direction of movement of the second vehicle from the plurality of feature points of the vehicle;
the extracting, detecting, and tracking detects, in the image acquired, a tire of the second vehicle being tracked, extracts a feature point in the tire detected and a neighboring area, and adds the feature point extracted to the feature points of the second vehicle, and
the extracting, detecting, and tracking detects the tire of the second vehicle by detecting, in the image acquired, a vertically long ellipse in accordance with a parameter of the imaging device.
